(19) United States
(12) Patent Application Publication
(10) Pub. No.: US 2022/0345428 A1
(43) Pub. Date: Oct. 27, 2022

(54) SYSTEM AND METHOD FOR SECURED COMMUNICATIONS

(71) Applicant: Michael Luu, Irvine, CA (US)

(72) Inventor: Michael Luu, Irvine, CA (US)

(21) Appl. No.: 17/241,721

(22) Filed: Apr. 27, 2021

(51) Int. Cl. H04L 12/58; H04L 29/06

(52) U.S. Cl. CPC H04L 51/18; H04L 51/08; H04L 51/12; H04L 51/22; H04L 63/0485; H04L 63/108

(57) ABSTRACT

The embodiments of the present invention are directed to various implementations of a system and/or method for protecting the confidential information that may exist within the contents of electronic communication, such an email or attachment to the e-mail. A system administrator of a secured application according to the embodiments of the present invention can configure various criteria, or combinations of criteria, for triggering the application of one or more e-mail protection functions (EPFs) to be applied to the communication before it is sent; the EPFs may include the encryption of the e-mail or attachment, storing of the e-mail or attachment on a secured server, or otherwise restrict access to the communication by unauthorized recipients.

### BACKGROUND OF THE INVENTION

The present invention is directed to a system and method for increasing the security of transmitting confidential or sensitive information over an email or other similar communication systems.

### BACKGROUND OF THE INVENTION

Electronic communication, including e-mail, text messages, or other forms of instant messages, dominate the manner by which people communicate, including the communication of sensitive data information. As well, many forms of electronic communication, including e-mail, are susceptible to security breaches, either accidentally or by actors with malice intent. Often, these breaches can lead to the compromise of confidential or sensitive information, including confidential financial information, patient health information (PHI), etc.

For most businesses, email is primary method for communications for internal and external users. In regulated industries dealing with more regulated and/or confidential data such as healthcare and finance, users are frequently sharing information with colleagues and external users. These emails may require some of the regulated and/or confidential data in the content or attachments. Current industry methods and recommendations rely on training users to minimize the amount of regulated and/or confidential data sent, and for users to activate encryption security of the email when users know there is important data. This poses multiple issues. This relies on the sending user assessing when an email contains regulated and/or confidential information, such as patient health information (“PHI”).

In the healthcare field that fall under HIPAA regulations, PHI has to be protected. When there is an incident, breach, or data loss, the entity has to report the event to U.S. Department of Human Health Services (HHS). Within the reporting, all PHI data that is potentially loss to an intruder must be reported. In the event that it cannot be determined if a perpetrator stole or accessed a record, the record must also be reported. If adequate protection is not in place, the entity would be vulnerable to stiff fines and civil claims. Many of the current systems take on specific technical functions, such as encryption of an email, access rights for specific users, logging illegal access, etc. With these, there is a major reliance on the training of users and the users actually following the procedures provided in the training. Users are supposed to judge if an e-mail and/or the attachments to the email includes PHI. If it there is PHI, users are to manually execute procedure to encrypt the email before sending. Users may also be required to delete the email over time so that the amount of emails will not build.

Several methods and technologies exist to reduce the risk of data breach. These methods and technologies can be generally broken down to communication encryption system on the one hand, and data classification tools on the other hand.

Communication encryption systems: One manner by which measures are taken to reduce the likelihood of data breach is to use encryption applications for e-mails so as to protect the encrypted information from being compromised. Currently, many email encryption applications and services exist to encrypt emails. Many of these applications and/or services are available as software as a service (“SAAS”) products, software, and/or hardware software combinations thereof. These different solutions offer various different algorithms for encryption of the communication content, and the methods by which recipients may receive or retrieve email. For instance, certain systems can be configured to encrypt all email communications, or only emails that the sending end user initiates by clicking on a button or typing in a keyword such as SECURE in the subject line.

Within the category of encryption services and applications, there exist email systems that operate with core business functions and encrypts all emails that come to and from those core functions. Many companies in this segment including Proofpoint, Symantec, Ironport (Cisco), Mimecast. An example of the use of these types of application is by the mortgage industry employees, such as a mortgage broker, sending out to mortgage applicants' paperwork, which typically contain financially sensitive information. The mortgage paperwork comes as a separate email that is encrypted as it comes from one particular system that handles the official paperwork; but, normal, non-secure communication with a mortgage broker may not encrypted, and the mortgage broker will need to exercise caution in using the non-secured e-mail system to communicate potentially confidential information. Since mortgage brokers are humans and make human errors, it is not an uncommon occurrence that confidential information may be accidentally communicated over non-secure e-mail transactions.

While encryption techniques may reduce incidences of data breach, they are far from perfect in terms of overall data breach protection. These techniques rely on the encryption being activated correctly, emails being deleted when no longer needed, user account not being illegally accessed, and tools to help forensics determine which emails are exposed in a security incident.

There are system that that encrypt all emails, even at the endpoint, and requires a recipient to click on a link to another system, where they would need to provide additional log-in credential to see the email. Such systems can become unnecessarily overburdening because in such systems all email, including ones that have only content that do not require encryption, requires the recipient to be hindered by having to click on link and log into another site to see less confidential emails. Even a simple “how are you doing?” would be encrypted. This is important as emails cannot be read via the email applications on mobile phones. This also prevents many emails from being views in areas where internet connection is inconsistent or not available.

In systems that separate normal email and emails that are encrypted require users to be trained consistently to know what content can be sent in the normal non-encrypted email account and what should not be sent. Users will only use the encrypted email system to pass confidential information. User errors in emailing confidential information would allow for transmission and storage or confidential information in unencrypted form, as they use the wrong systems. Users being human will make mistakes over time. Other users will simply fail to follow policies for separating secured from unsecured e-mail communications. Each email they send that is not encrypted properly is a data-breach risk in the sender's sent folder and the recipient's inbox. In regulated industries that require the type of data to be encrypted, this may mean the sender is out of legal compliance. There may be risk of the email during transit over the internet. Any response back and forth between sender and recipients will increase the risks further.

Furthermore, while communication encryption systems can help reduce data breach during the transmission of the data, they typically do not prevent data breach for data that is stored in a network or received by (and decrypted by) an end user. Some systems encrypt the communication content only during transit, with the content becoming unsecured upon reception by the receiver. In one example, person A sends an encrypted email to person B. The email is encrypted in transit; therefore, a hacker getting a hold of that data in transit will not easily decipher the contents of the email. However, once the content is received by person B and is decrypted, it is still susceptible to hacking and data breach. In these situations (which is common), emails remain unencrypted in the account. If an unauthorized person gets access to the email account with login credentials, they will have access to all the emails in the account. Users tend to keep most emails in the account and not delete them on a regular basis. This leaves a large amount of data at risk if the login credential is stolen or breached. At the enterprise level, there are many regulations that places high penalties for not securing data, especially in cases of a security breach. Although most IT professionals may encrypt all sensitive data at rest, once a user has a login credential breached, that encryption at rest is useless as they would see what a user would normally see in the email account. Email phishing attacks is a common method to get login access to end user accounts. In cases regarding HIPAA regulations in the healthcare world, if an account is breached, the entity owning the account may not know which emails were accessed by the hacker, so therefore, the entity would have to notify all patients that have any data in any email in account.

Typically, solutions that encrypts emails in transit do not have expirations on the files at the recipient inbox or the senders Sent folders. Only some systems that hold/store the encrypted email in another system and require the recipient to link over to another system and login, have an expiration for the link or email. Without an expiration, the amount of data and files in the account build up over time that may place a high risk to the entity if that particular account is breached.

Separately, data-classification tools are solutions that classify data as confidential within a network, including contents of emails that have been sent or received. Currently, vendors of data classification systems include Varonis and Sailpoint. These system survey and analyze the network storage for types of data such as patient health records, credit card information, social security numbers, and others that the system administrator may program as protected data. These system can be run as point in time or monitor over time, and can be used to generate reports showing the location of data that have meet certain criteria that classify it as protected data. With the protected data being identified, the system administrator can install encryption solutions to encrypt such data while in storage. These solutions only classify the data throughout the network, after the fact the content files are made. These systems do not help prevent data breach if an electronic communication that is supposed to be encrypted was communicated without encryption and has already been sent.

There exists a long-felt need for a comprehensive system or solution that protects all confidential data being communicated both during transit and after its receipt, while minimizing data breach risks that may be caused by human error, a solutions that encrypts regulated or confidential data identified inbound/outbound traffic and while in storage, and reducing the amount of unnecessary confidential data in storage.

### BRIEF SUMMARY OF THE INVENTION

It is an objective of the present invention to provide a secured communication system that minimizes or dramatically reduces incidences of data breach within electronic communication environment.

It is an object of the present invention that the solution be able to integrate with popular email solutions or to other tools such as data classification tools.

Embodiments of the present invention automate key specific manual steps that were previously reliant on users to carry out in that the system can be programmed to detect sensitive or confidential data and execute procedures in a consistent manner, and also incorporate other key functions into the automated process, so as to protect the sensitive or confidential data. This automation may utilize artificial intelligence or machine learning code and tools to access and execute actions (steps).

A system in accordance with one embodiment of the present invention is triggered simply by a user hits “SEND” to send off an e-mail communication. Upon “sending” an email, a system in accordance with the embodiments of the present invention can automatically detect whether the to-be-sent email includes sensitive or confidential data, upon such detection securely encrypt the email. In accordance with one embodiment, the encryption includes the email itself and its contents, including text, address, and attachments.

A system in accordance with one embodiment of the present invention further provides secure mechanisms for receiving electronic communications, including e-mail, by the intended recipient.

A system in accordance with one embodiment of the present invention further provides a login (multi-factor authenticated) repository for data storage.

A system in accordance with one embodiment of the present invention further provides a time-based auto deletion within the repository for files. User are able to configure the time or other criteria for files to be automatically deleted.

A system in accordance with one embodiment of the present invention further provides a log or monitoring system for monitoring activities relating to the protected data.

In accordance with one embodiment, the client side will be either an independent or an “Add-on” application that works with various email programs. In the Add-on form, the application is agnostic to what email program that is being used and can sit within the email program.

A system in accordance with one embodiment of the present invention transfers encrypted email in an encrypted database separate from the email server.

A system in accordance with one embodiment of the present invention further adds a timestamp on when the encrypted email was sent, and when the email should be deleted.

A system in accordance with one embodiment of the present invention further creates the email to be transmitted with link to encrypted email, which is stored in an encrypted email database. In accordance with another embodiment, such links will expire after a finite time period.

A system in accordance with one embodiment of the present invention further removes/deletes original email to prevent it from being saved in native form on the email server, and optionally also prevent auto-forwarding of the e-mail.

A system in accordance with one embodiment of the present invention further removes/deletes original email to prevent it from being saved in native form on the email server, and only allow recipient and sender to see the email after login into an encrypted database through a portal (website). Optionally, functions such as printing, copying, downloading, etc. would be restricted for all user or for certain users.

In accordance with one embodiment, a link to an encrypted email will open up a portal to the encrypted email database or other similar encrypted system. Users can be provided with one of many processes to create and verify an account that is not limited to include username, password, multifactor authentication in its various forms (including sending a passcode to a mobile-phone of record), physical devices, or services. Users can log into this system with various authentication processes. Logging in will allow user to see the encrypted email.

### BRIEF DESCRIPTION OF THE DRAWINGS

FIG. 1 is a schematic illustration of a system in accordance with one embodiment of the present invention;

FIG. 2 is a block diagram illustrating an algorithm employed by one embodiment of the present invention;

FIG. 3 is a block diagram illustrating an algorithm employed by another embodiment of the present invention; and

FIG. 4 is a block diagram illustrating an algorithm employed by a further embodiment of the present invention.

FIG. 5 is a block diagram illustrating an algorithm employed by a further embodiment of the present invention.

FIG. 6 is a block diagram illustrating an algorithm employed by a further embodiment of the present invention.

FIG. 7 is a block diagram illustrating an algorithm employed by a further embodiment of the present invention.

FIG. 8A is a block diagram illustrating an algorithm employed by a further embodiment of the present invention.

FIG. 8B is a block diagram illustrating an algorithm employed by a further embodiment of the present invention.

FIG. 9A is a block diagram illustrating an algorithm employed by a further embodiment of the present invention.

FIG. 9B is a block diagram illustrating an algorithm employed by a further embodiment of the present invention.

FIG. 10 is a block diagram illustrating an algorithm employed by a further embodiment of the present invention.

FIG. 11 is a block diagram illustrating an algorithm employed by a further embodiment of the present invention.

FIGS. 12A-12E illustrate a user interface in accordance with one embodiment of the present invention.

FIGS. 13A-13B illustrate another user interface in accordance with one embodiment of the present invention.

FIG. 14 illustrates yet another user interface in accordance with one embodiment of the present invention.

### DETAILED DESCRIPTION OF THE INVENTION

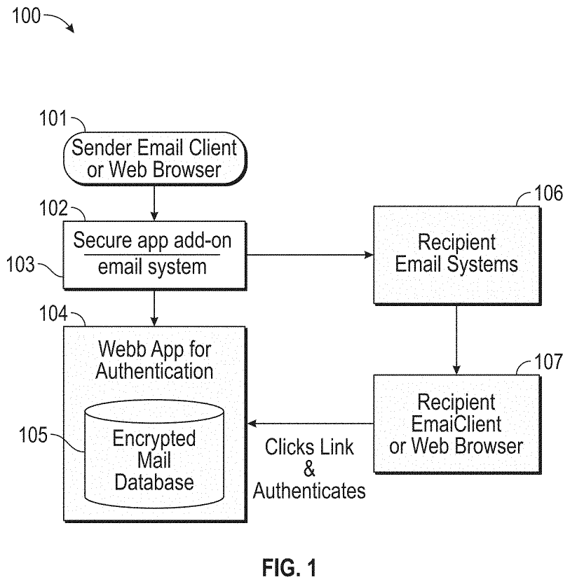

Detailed description of the various embodiments of the present invention is provided below with references to FIGS. 1-14.

FIG. 1 illustrates an overall system configuration according to one embodiment of the present invention. Specifically, shown in FIG. 1 is a secured communication system 100 that includes a sender apparatus 101, which can be an e-mail client or a web browser, that communicates with an e-mail system 103 having a secured application 102 (which can be integrated as a part of the e-mail system or be appended as an add-on application (as shown), which communicates with, on the one hand, a recipient e-mail system 106 and, on the other hand, a web application 104 for authentication, included within (or, in an alternative embodiment, operatively connected to) an encrypted mail (or encrypted data) database 105. The web application 104 communicates with a recipient e-mail client (or web browser) 107 that communicates with the recipient e-mail system 106.

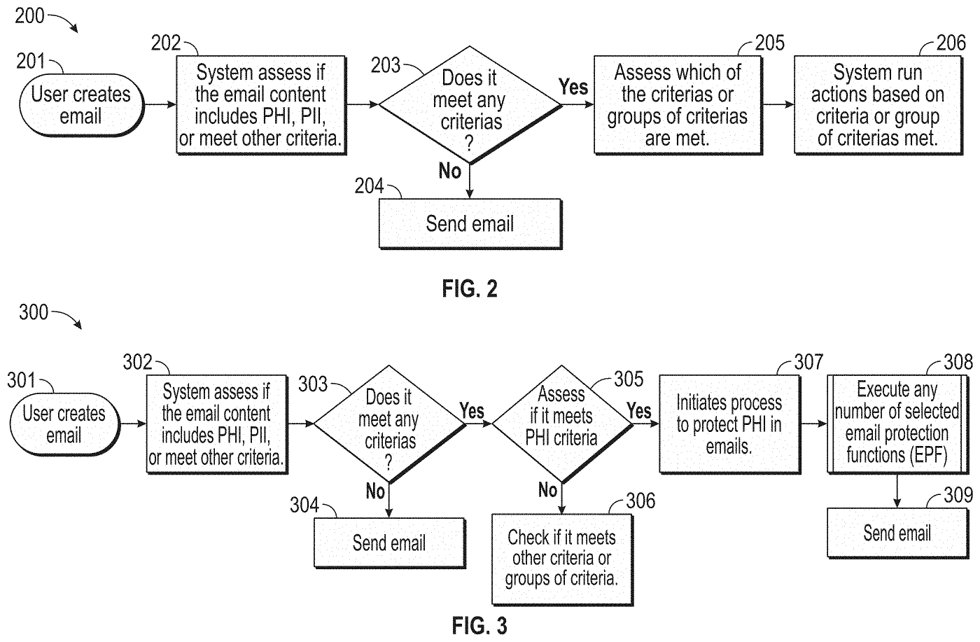

FIG. 2 is a block diagram illustrating algorithmic steps of the present invention in accordance with one embodiment. Specifically, as shown in FIG. 2, a user initiates the system by creating an e-mail 201. It should be noted that other forms of electronic communications, such as instant messages or text messages, etc., are also contemplated within the scope of the embodiment. Upon receiving a to-be-sent e-mail 202, the system determines 203 whether the content of the e-mail meets any criteria, such as including confidential data (either the e-mail itself or attachments thereto), such as PHI or PII. If the content does not include any confidential data or otherwise meet any criteria that warrant further action, the system proceeds to send the e-mail 204 unsecured through normal channel of communication. If the e-mail contains confidential data (or meets a criteria), the system further assess which type of confidential data (or which kind of criteria) is met 205 and in response thereto execute 206 certain set of pre-associated actions, such as e-mail protection functions (“EPFs) based on the determination. It should be noted that although the term “e-mail” is used throughout this specification, the term is intended to encompass all forms of digital or electronic communication including text messages, instant messages, social-media communications, chats, etc.

FIG. 3 illustrates an alternative embodiment of the algorithm illustrated in FIG. 2. Specifically, as shown in FIG. 3 at step 305, if PHI is specifically identified by the system, then EPF(s) specific to the PHI will be initiated 307 and executed 308 before the outgoing e-mail is sent 309.

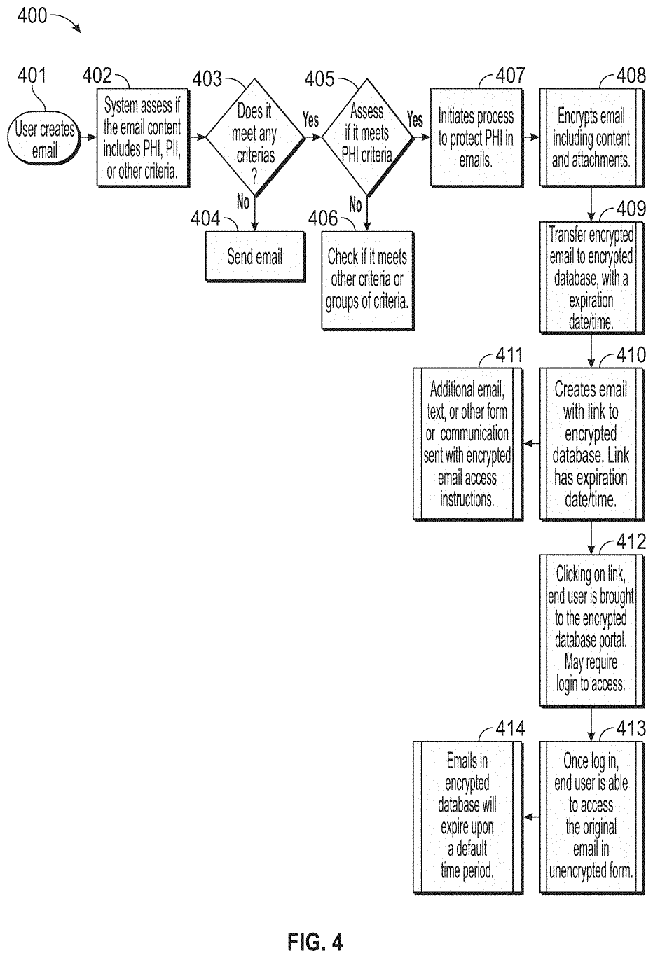

FIG. 4. Illustrated a specific embodiment of the present invention in which additional steps are illustrated from the embodiments shown in FIGS. 2 and 3. Specifically, in this embodiment, after an outgoing email is encrypted 408, the encrypted outgoing e-mail is transferred to an encrypted database 409. The system then creates a notification e-mail 410 that includes a clickable link, and optionally inserts any additional access instructions 411, to allow the intended recipient of the outgoing e-mail to securely access the stored e-mail. Once a user receives the notification e-mail and clicks on the generated link 412, the user is brought to a login page to enter his or her credentials 413. The system administrator can set an expiration period for the encrypted e-mail such that if the e-mail is not accessed within that period of time the link will expire and the stored e-mail can be deleted 414. A person of ordinary skill in the art would understand that if a login system is to be used, user credentials will need to be pre-stored so that verification can be performed upon login access.

Criteria configuration and examples of e-mail protection functions are discussed in further detail below.

### Detailed Description of Criteria Configurations

The general goal of criteria configuration is to identify any data contained in electronic communication that should be protected. Such data include patient health information, financial records, credit card information, possible intellectual property, or any other privacy significant information that may be regulated or of value to an entity that needs to be kept confidential. The scope of the present invention encompasses at least any common or known method by which criteria may be configured akin to those employed by state-of-the-art data classification tools.

One example of method by which criteria may be configured include the use of keywords (e.g., certain codes or common words found in specific types of confidential data), data types such as social security number, or combinations of data types. For instance, in the healthcare industry, exemplary keywords that can be used may include social security number, full name, address, birthdate, social security number, medical ICD codes, or some combination of keywords or data types. This configuration can also be set to follow governmental criteria rules that some industry may require compliance. In this example, U.S. HIPAA rules have guidelines that designate what is considered PHI, and the levels of security necessary for the PHI or combination of PHI available. The system can be configured to follow current government agency guidelines. It can also be set to use multiple government guidelines and/or user designated criteria.

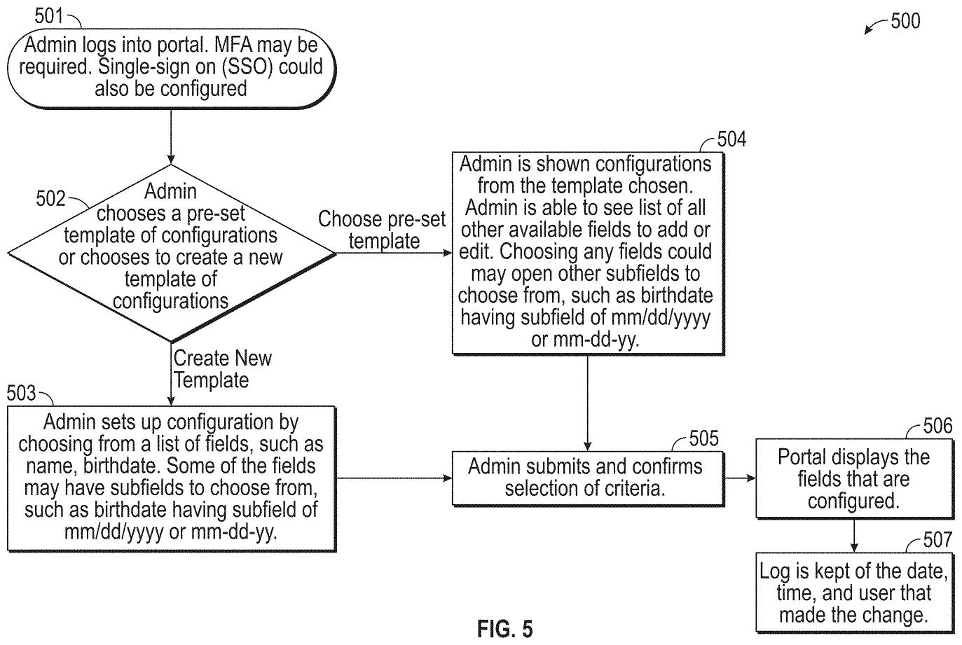

To provide a specific example, FIG. 5 illustrates an algorithm by which criteria may be configured under this embodiment. As detailed in FIG. 5, the system administrator logs into a system of one embodiment 501, which can be via a single-sign on login (SSO login) or a multi-factor authentication login (MFA), after which the administrator can configure the criteria to be used in determining whether EPFs are to be deployed. Specifically, as shown in step 501, in accordance with one embodiment, the administrator may choose an existing template with a set of pre-determined configurations or chooses to create new template of configurations. If the administrator chooses to use a pre-set template, then in step 504 the administrator is shown configurations from the template chosen. In one embodiment, the administrator is able to edit the chosen pre-set configuration by choosing which data fields that he/she wants to configure as criteria by clicking on a check box next to the data types. Some check boxes may open up further fields or choices to further define the data field setting. The following are some examples of data fields to choose from:

Text or Keyword
Birthdate
Social Security Number
Driver's License number
First name
Last name
Full name
Address
Mother's maiden name

Any fields that were previously configured from existing template would be there and can be edited. At step 505, the administrator submits and confirm after selection of data points are configured. Portal will then display 506 what fields have been configured. Log is kept 507 of the date, time, and user of the change.

Another example of method by which criteria may be configured include having the administrator create a new template 503 to recognize format(s) of a particular data field (e.g., a 10-digitit number may represent a phone number, or a particular digit number may represent patient ID, or a 9-digital number in the format of XXX-XX-XXXX may represent a social security number, etc.). For instance, in the healthcare industry, exemplary form factors that can be used may include xxx-xx-xxxx for social security number, xxxxxxxx for California driver license, name, xx-xx-xx or xx-xx-xxxx birthdate, address, medical report information, or other information. The combination of some of these form factors may also be used to determine the criteria. Steps 505, 506, and 507 can follow step 503 as described above.

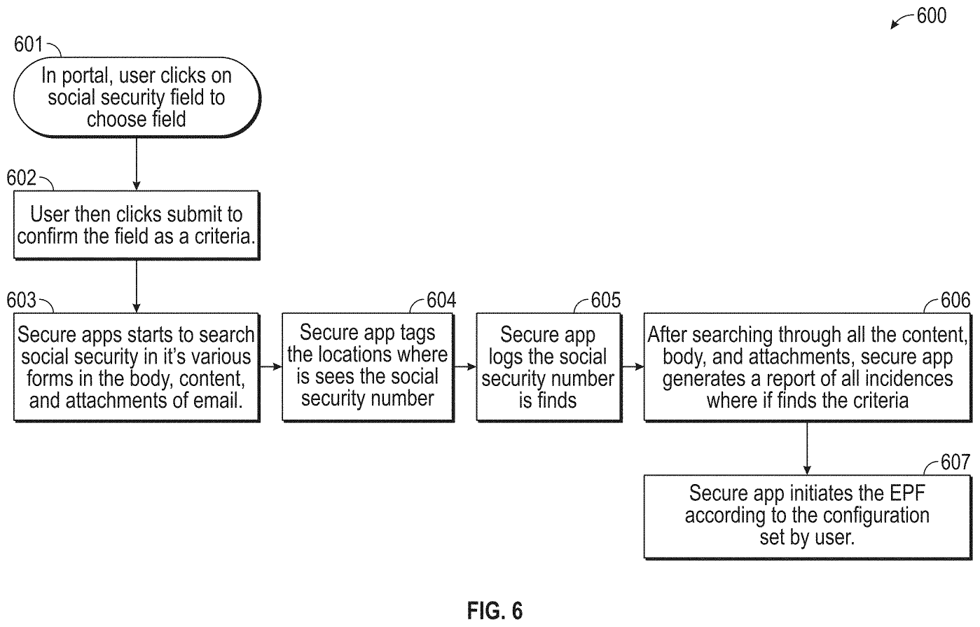

In accordance with another embodiment relating to criteria configuration, FIG. 6 illustrates an algorithm by which criteria may be configured without a specific data format. Specifically, in step 601 by way of example, the administrator user can choose and confirm 602 the social-security number field as a criteria to be configured, but without specifying the data-field form factor (e.g., xxx-xx-xxxx); optionally, the administrator can specify the data-field form factor if he or she wishes to narrow the search. In response, the secured application in accordance with one embodiment of the present invention will search the content of the electronic communication, including attachments, for any possible social security number information 603 and tag the same 604. In determining whether social security information is present, the secured application may search for contextual information including without limitation the words “Social Security” or social securities in upper or lower case, the words social security number or social security numbers, in upper or lower case, the words SSN, SSN's, etc., and/or “xxx-xx-xxxx,” or nine-digit number with or without dashes. Upon determining the existence of social security information, the secured application optionally logs the findings 605, generates a report 606, and initiates EPF(s) according to the administrator configuration 607.

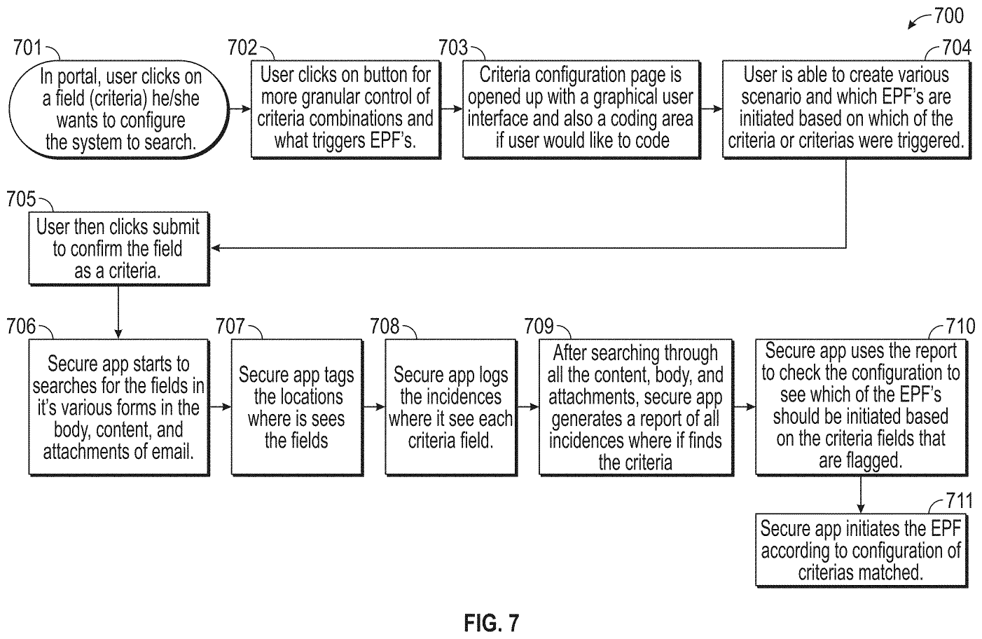

FIG. 7 illustrates another algorithm for criteria configuration for triggering the application of EPFs in accordance with one embodiment of the present invention. Specifically, in accordance with one embodiment, a system administrator can choose a scenario under which more than one criteria or a specific combination of multiple criteria as condition precedent for triggering one or more EPFs. For instance, in the criteria configuration page 703, the administrator can configure (via graphical interface or some basic coding-like method) what they system would be looking for in terms of multiple criteria. For instance, system may look for one of name, social security, or birthdate. Under one configuration, if all three fields exists, the system may determine the communication to be confidential. On the other hand, if only social security number and birthdate exists, the system may be configured to look for one of the other criteria like driver's license or mailing address to determine whether the communication should still be deemed as confidential and EPF is triggered. The administrator can also set which of the EPF (described in further detail below) is triggered if a pre-determined combination of criteria exist.

### Detailed Description E-Mail Protection Functions

Detailed descriptions are provided below with respect to various EPFs that may be deployed in connection with the embodiments of the present invention.

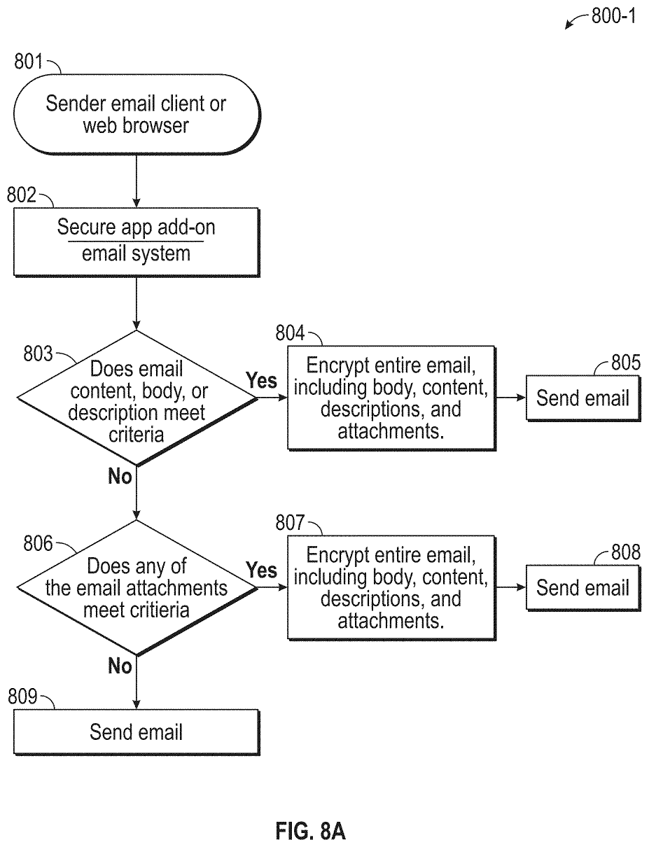

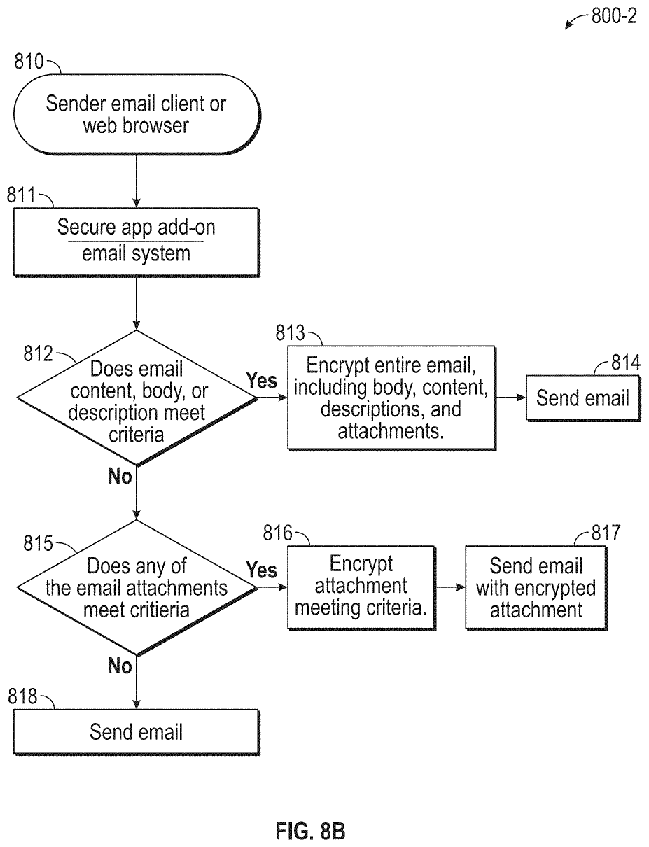

One EPF is to encrypt the contents and/or attachment of the message before sending the e-mail. In accordance with one embodiment, as shown in FIG. 8A, if either the cover e-mail or the attachment includes confidential information that meet the configured criteria, then both the communication itself and the attachments are encrypted before sending the e-mail. In accordance with another embodiment as shown in FIG. 8B, if the cover email message itself does not contain any confidential information or otherwise does not meet any other criteria for protection, but an attachment (e.g., a tax return) does, then the system will encrypt only the attachment and not the cover e-mail. In accordance with one embodiment of the present invention, the secured application add on e-mail system 102 can first perform the optical character recognition (“OCR”) on any attachments before executing the criteria comparison functions, so as to capture any confidential information that may otherwise not be recognized due to the graphical nature of the attachment; a person skilled in the art would understand that various state-of-the-art OCR engines can be incorporated into the system; alternatively, the system 102 can call up other application programs, such as an appropriate version of Adobe Acrobat, to perform such function.

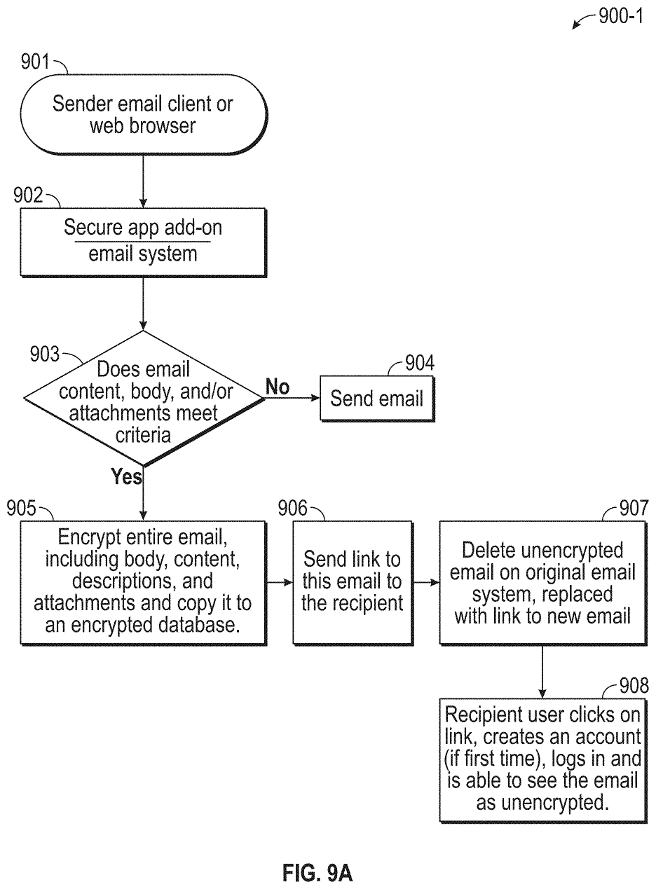

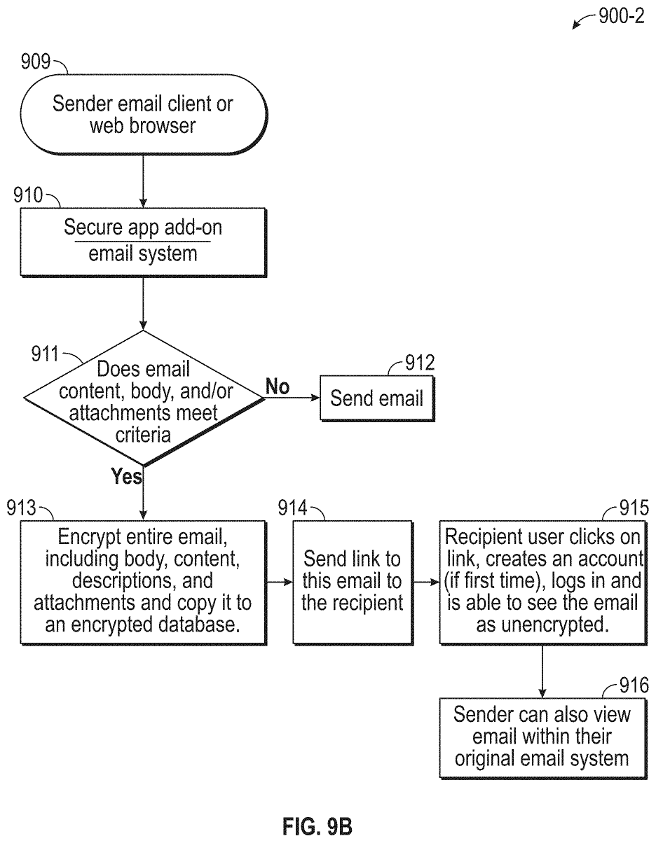

Another EPF to provide a secured mechanism for the intended recipient to receive or retrieve the identified confidential data/communication is illustrated in FIGS. 9A and 9B. By way of example, as illustrated in FIGS. 9A and 9B, the entire email, the email body, the attachment, or combination of email body and attachment can be copied to an encrypted database. In one embodiment, as shown in FIG. 9A, the original email on the email system will be deleted and replaced with an email with a link to the encrypted database and some information and disclaimer about the encrypted link. User will be able to log in or create a login to the encrypted email database. Once log in occurs, and authentication is complete, user will be able to see the portion of the original email that was encrypted. This may include the entire email. Emails within the encrypted database can be encrypted together or separately. In accordance with another embodiment, the original email is not deleted from the sending system. In accordance with another embodiment, the email is replaced with a message that the email has been moved to the encrypted database from the sending system.

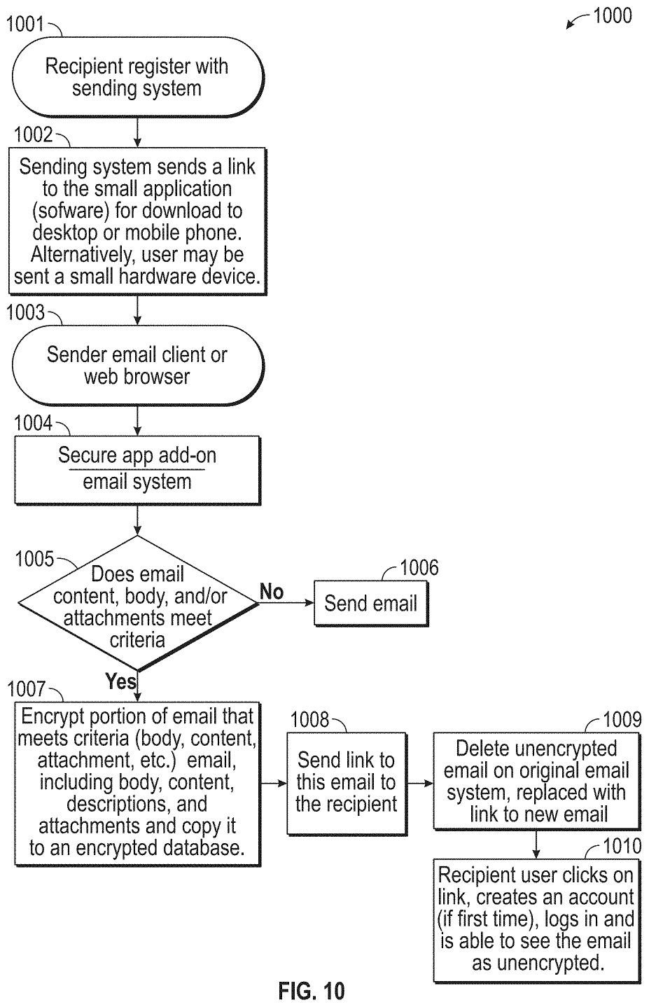

Another EPF to provide a secured mechanism for the intended recipient to receive or retrieve the identified confidential data/communication is illustrated in FIG. 10. By way of example, as shown in FIG. 10, the entire email, the email body, the attachment, or combination of email body and attachment will be encrypted and then copied to an encrypted database. The original email on the email system will be deleted and replaced with an email with a link to the encrypted database and some information and disclaimer about the encrypted link. User will be able to log in or create a login to the encrypted email database. Once log in occurs, and authentication is complete, user will be able to see the portion of the original email that was encrypted. This may include the entire email. In one embodiment, the EPF can further verify the IP address of a user attempting to login by comparing it to the pre-stored IP address of the intended recipient of the secured communications; alternatively, this could be established as an additional, optional EPF (such EPFs may not work well if the intended recipient does not have a static IP address).

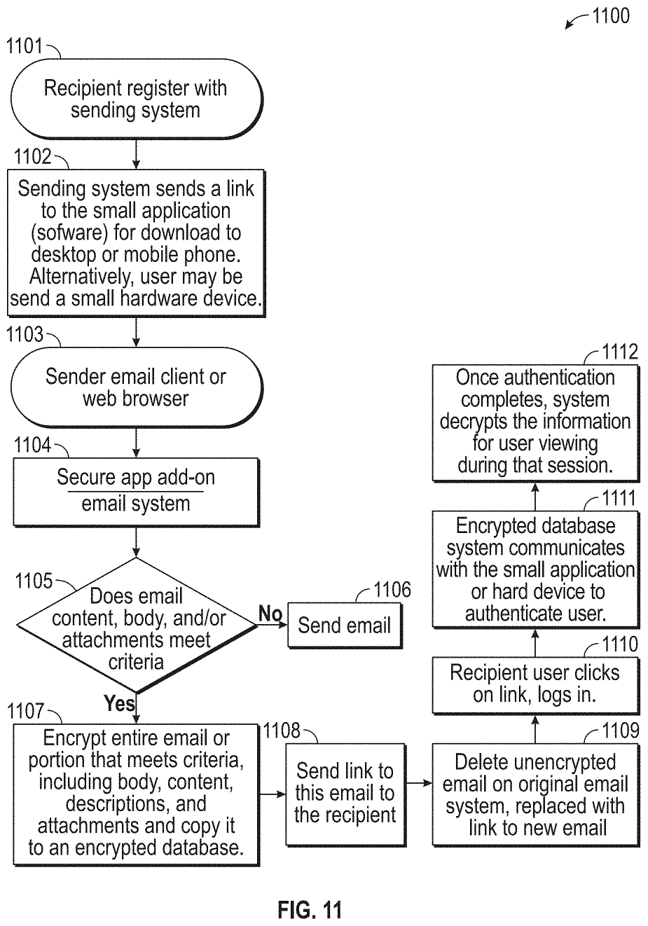

Another EPF to provide a secured mechanism for the intended recipient to receive or retrieve the identified confidential data/communication is illustrated in FIG. 11. As shown in FIG. 11, a recipient may have registered with the sending recipient and/or its system. The recipient receives a software or small portable hardware (can be USB enabled or other common port). The email will be encrypted at sender into the encrypted database. The recipient would need to use the software from sender or the small portable device in their computer. Once they use the device, they log into the encrypted database portal to see the email. The portal will be communicating with the software or portable hardware device to confirm user's identity. In accordance with another embodiment, the encrypted database portal may be using a verification via Bluetooth or some other mechanism with the recipient's mobile phone.

### Exemplary Embodiment of System Administrator Interface

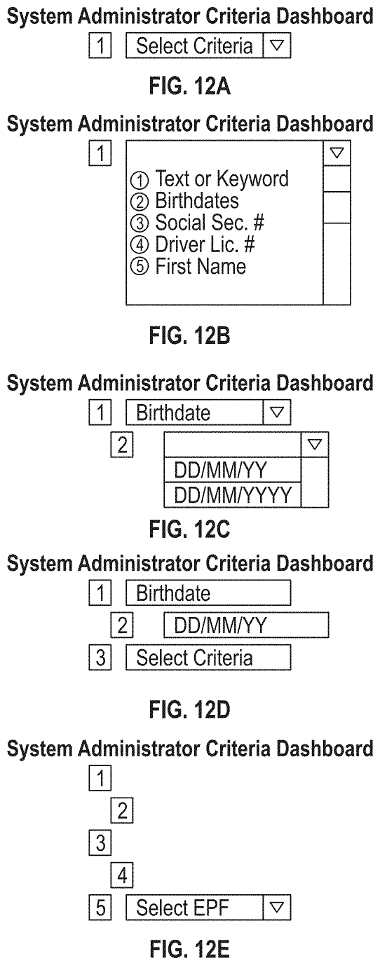

FIGS. 12-14 illustrate a system administrator graphical user interface to be displayed at the interface terminal of the system administrator in accordance with one embodiment of the present invention. Such a user interface can be optionally remotely connected into the secured application add-on system 102. Further detailed descriptions are provided below.

FIG. 12A illustrates a system administrator interface in accordance with one embodiment in which a dashboard is displayed for configuring criteria to be used for determining whether EPF(s) are to be executed. In this embodiment, the system administrator can click on (or mouse over) the criteria field to cause a display of selectable criteria to be chosen by the system administrator, as shown in FIG. 12B. FIG. 12C illustrates an embodiment by which upon the system administrator selecting a criterion (e.g., birthdate), the administrator can further specify the data format of the confidential information to be searched; in one embodiment, the system administrator can select multiple data format to be searched. Amongst the options of data format selection includes the option to require contextual text surrounding the data to be searched (not shown in FIG. 12C). For example, in order to distinguish a birthdate from any other dates, a contextual limitation can be added by which the term(s) “birthdate” or “date of birth” must also be present within a pre-set proximity of the data to be searched (for instance, within 10 words of the data to be searched). In this instance, a system administrator can select a particular type of data format (as shown in FIG. 12C) and also require that the date found be within 10 words of the word “birthdate” or “date of birth” (again, this is not explicitly shown in FIG. 12C). Similarly, in the search for a nine-digit number, the system administrator can require a contextual condition of also finding the term “social security” within certain proximity of the number found. In accordance with one embodiment, as shown in FIG. 12D, a system administrator may select an additional (or multiple) criterion to be met as a pre-condition for executing EPF(s). FIG. 12E illustrates one embodiment by which the system administrator, in similar fashion described above with respect to criteria configuration, and further configure and select the EPF(s) to be executed upon criteria match.

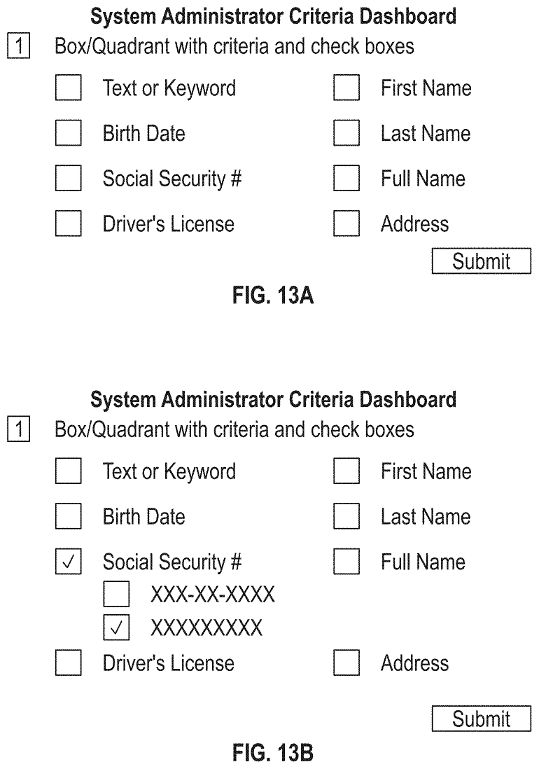

FIG. 13A illustrates another embodiment according to the present invention by which a system administrator may configure criteria for checking whether any contents of the to-be-sent communication should be protected. As shown in FIG. 13A, instead of using a drop-down menu for selecting one criterion at a time, a system administrator can select multiple criteria at the same time. FIG. 13B illustrates one embodiment by which for each of the criterion selected, additional options relating to data format can also be selected to further narrow the search parameter. In this instance, upon selecting “social security” as one of the criteria, different data formats typical of how social security numbers are entered can be selected.

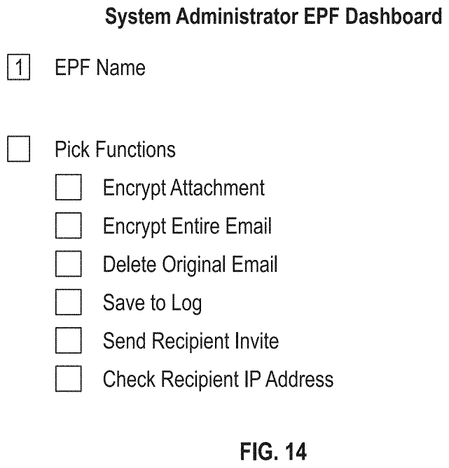

FIG. 14 illustrates an EPF configuration interface according to one embodiment of the present invention. As shown in FIG. 14, a system administrator can select or create a custom EPF, including creating a name for the custom EPF (e.g., “outgoing e-mails”). In configuring a custom EPF, the system administrator can select which of the pre-programmed functions (e.g., encrypt attachment) to be included in the custom EPF, by checking the box of the functions to be selected.

In accordance to one embodiment of the present invention, once the system administrator configures (or confirms) the appropriate criteria, and once the associated EPFs are also selected, the security add-on e-mail protection system 102 can be activated and be ready to protect outgoing electronic communications.

Those in the art will understand that a number of variations may be made in the disclosed embodiments, all without departing from the scope of the invention, which is defined solely by the appended claims. For instance, by way of example, the present invention can also be applied to receiving electronic communications from outside users (e.g., customers or clients). Systems according to embodiments of the present invention can be configured to match criteria to the incoming electronic communication and execute EPFs before they are either passed on to the intended recipients or be stored in the system storage. A person of ordinary skilled in the art would be able to, in light of the above detailed description, to configure the disclosed secured add-on e-mail system to either outgoing or incoming electronic communications, or both.

1. A method for secured electronic communication, said method being performed by a secured communication system comprising the steps of:
receiving an outgoing e-mail message to an intended recipient;
determining whether contents of the outgoing e-mail message meet at least one pre-configured criteria;
executing an e-mail protection function in response to a determination that the contents of the outgoing e-mail message meet the at least one pre-configured criteria wherein the e-mail protection function comprises:
encrypting the contents of the e-mail to generate encrypted data;
storing the encrypted data in an encrypted database;
generating a notification e-mail, wherein the notification e-mail includes an access link to access the encrypted data stored in the encrypted database;
sending the notification e-mail to the intended recipient of the outgoing e-mail;
in accordance with receiving an indication that a user has selected the access link, presenting to the user a login page associated with the encrypted database;
receiving login credentials entered by the user into the login page;
determining whether the login credentials entered by the user match login credentials associated with the intended recipient; and
in accordance with a determination that the login credentials entered by the user match the login credentials associated with the intended recipient, granting access to the stored protected outgoing e-mail via the encrypted database.

2. The method of claim 1, wherein the e-mail protection function further comprises pre-associating the e mail protection function with the at least one pre-configured criteria.

3. The method of claim 1, further comprising the steps of:
determining whether the outgoing e-mail message includes an attachment;
determining whether the contents of the attachment meet the at least one pre-configured criteria;
executing an e-mail protection function with respect to the contents of the attachment in response to the determination that the contents of the attachment meet the at least one pre-configured criteria.

4. (canceled)

5. The method of claim 3, further comprising encrypting the contents of the attachment.

6. (canceled)

7. The method of claim 1, further comprising setting an expiration date and time for the access link.

8. (canceled)

9. The method of claim 1, further comprising deleting the encrypted data from the encrypted database upon expiration of a preset time period.

10. The method of claim 1, further comprising receiving, from a system administrator, configurations to the at least one pre-configured criteria for determining whether to execute the e-mail protection function.

11. The method of claim 10, further comprising storing a pre-set template of configurations for configuring the at least one pre-configured criteria.

12. An e-mail communication system for facilitating secured electronic communication, the communication system comprising:
a sender e-mail client interface;
an encrypted database; and
a secure add-on e-mail system, said secure add-on e-mail system performing the steps of:
receiving an outgoing e-mail message to an intended recipient;
determining whether contents of the outgoing e-mail message meet at least one pre-configured criteria; and
executing an e-mail protection function in response to a determination that the contents of the outgoing e-mail message meet at least one pre-configured criteria, wherein the e-mail protection function comprises:
encrypting the contents of the e-mail to generate encrypted data;
storing the encrypted data in an encrypted database;
generating a notification e-mail, wherein the notification e-mail includes an access link to access the encrypted data stored in the encrypted database;
sending the notification e-mail to the intended recipient of the outgoing e-mail;
in accordance with receiving an indication that a user has selected the access link, presenting to the user a login page associated with the encrypted database;
receiving login credentials entered by the user into the login page;
determining whether the login credentials entered by the user match login credentials associated with the intended recipient; and
in accordance with a determination that the login credentials entered by the user match the login credentials associated with the intended recipient, granting access to the stored protected outgoing e-mail via the encrypted database.

13. The system of claim 12, wherein the secure add-on e-mail system further performs the step of pre-associating the e-mail protection function with the at least one pre-configured criteria.

14. The system of claim 12, wherein the secure add-on e-mail system further performs the steps of:
determining whether the outgoing e-mail message includes an attachment;
determining whether the contents of the attachment meet the at least one pre-configured criteria;
executing an e-mail protection function with respect to the contents of the attachment in response to the determination that the contents of the attachment meet the at least one pre-configured criteria.

15. (canceled)

16. The system of claim 14, wherein the secure add-on e-mail system further performs the steps of encrypting the contents of the attachment.

17. (canceled)

18. The system of claim 12, wherein the secure add-on e-mail system further performs the step of setting an expiration date and time for the access link.

19. (canceled)

20. The system of claim 12, wherein the secure add-on e-mail system further performs the step of deleting the encrypted data stored on the encrypted database upon expiration of a preset time period.

21. The system of claim 12, wherein the secure add-on e-mail system further performs the step of receiving, from a system administrator, configurations to the at least one pre-configured criteria for determining whether to execute the e-mail protection function.

22. The system of claim 21, wherein the secure add-on e-mail system further performs the step of storing a pre-set template of configurations for configuring the at least one pre-configured criteria.

23. The method of claim 1, wherein the user is the intended recipient.

24. The method of claim 1, further comprising:
receiving, via the login page, an indication that the user is a first-time user;
in accordance with the indication that the user is the first-time user, receiving the login credentials from the user; and
associating the login credentials with the intended recipient.

25. The method of claim 1, wherein the e-mail protection function further comprises sending instructions to an e-mail client to delete the out-going e-mail, wherein the e-mail client generated the outgoing e-mail message.

26. The method of claim 1, wherein the e-mail protection function further comprises sending instructions to an e-mail client to replace the out-going e-mail message with the e-mail notification including the access link, wherein the e-mail client generated the outgoing e-mail message.
